(19) United States
(12) Patent Application Publication
(10) Pub. No.: US 2012/0192637 A1
(43) Pub. Date: Aug. 2, 2012

(54) Method for Determining the Transverse Curve of a Generally Cylindrical Receiving Surface

(76) Inventors: Philippe Tramond, Saint Ours Les Roches (FR); Jean-Yves Denoueix, Blanzat (FR); Bernard Guerinon, Clermont-Ferrand (FR)

(21) Appl. No.: 13/380,028

(22) PCT Filed: Jun. 14, 2010
(86) PCT No.: PCT/EP2010/058297

§ 371 Date: Apr. 13, 2012

(30) Foreign Application Priority Data
Jun. 19, 2009 (FR) 0902998

(51) Int. Cl. G01M 17/02

(52) U.S. Cl. 73/146

(57) ABSTRACT

Method for determining the transverse curve of a receiving surface of generally cylindrical form designed, during the assembly of the tire blank, to receive the components forming a crown belt in which threads are placed at zero degrees relative to the longitudinal direction, the threads being continuously wound without tension. The elongation rate (A) to be applied to a turn of a zero-degree thread is determined according to the desired pre-tension (A=f(T)), according to its axial position in the tire. Depending upon the radial position (Rf) of the thread of the said turn in the tire fitted into its mould, the initial radial position (Ri=Rf/(1+A)) is determined so that the thread of the turn in question sustains the desired elongation rate during forming in the press. The transverse profile (Rfdp) of the receiving surface is determined, in the axial location of the said turn, by subtracting from the initial position of the thread (Ri) the thickness (e) of the components placed radially inside the turn of the said zero-degree thread (Rfdp=Rf/(1+f(T)) e).

The invention relates to the field of tire manufacture and in particular to that of assembling components forming the crown of the tire.

Generally, reinforcing crown and tread plies are assembled on a receiving surface also called a crown form, the axial profile or curve of which is usually cylindrical.

The crown form consists of a set of radially movable elements making it possible to adjust the diameter of the form between an expanded position used during the assembly phase and a retracted position making it possible to extract the annular element obtained after this tire-construction phase.

The crowns of modern tires usually comprise reinforcing plies forming an angle with the circumferential direction, a reinforcing ply consisting of threads wound circumferentially and called the zero-degree ply or zero-degree threads, and a tread covering the assembly. Once put together, this annular element is transferred to the portion of the tire comprising the carcass reinforcing ply and the reinforcing rings of the beads on which a generally toroidal form has been conferred. The assembly then constitutes a tire element designed to be placed in a curing press for the curing operation.

In order to improve the performance of the tire, it is normal practice to vary the tension of the threads forming the zero-degree ply. Thus, to increase the maximum speed acceptable by the tire, efforts will be made to increase the pre-tension of the zero-degree threads situated in the shoulder zone and, to improve wear resistance, the pre-tension of the zero-degree threads situated in the central zone is increased.

Accordingly, many methods for placing the zero-degree threads in tension have been developed by the tire manufacturers that make it possible to vary the wrapping tension depending on the axial position of the zero-degree thread to be placed.

However, it is observed that, when it is sought to confer a considerable tension on the zero-degree thread, these stresses, combined with the elasticity of the threads, have the effect, when the tire element is released from the assembly machine, of causing a radial collapse of the crown, resulting in the formation of crease and the relative displacement of the products forming the crown.

The object of the invention is to propose an alternative solution to the wrapping under tension of the zero-degree threads by acting on the transverse curve of the generally cylindrical-shaped receiving surface designed, during the assembly of the blank of a tire, to receive the components forming a crown belt.

The method for determining the curve of the receiving surface according to the invention comprises the following steps during which:
the elongation rate (A) to be applied to a turn of a zero-degree thread is determined according to the desired pre-tension, according to its axial position in the tire,
depending upon the radial position of the thread of the said turn in the tire fitted into its mould, the initial radial position is determined so that the thread of the turn in question sustains the desired elongation rate during forming in the press,
the transverse profile of the receiving surface is determined, in the axial location of the said turn, by subtracting from the initial position of the thread the thickness of the components placed radially inside the turn of the said zero-degree thread.

Turn of thread in this instance means a portion of the thread corresponding to a complete turn of the thread.

In this manner, the zero-degree threads can be placed at constant and relatively high tension so as to avoid the drawbacks indicated above.

Once the tire element is in the press, the curing means, usually formed by an expandable membrane, will force the crown zone to enter the portion of the mould comprising the sculptures. During this operation, the radial displacements imposed on the zero-degree threads will be greater or lesser depending on the diameter of placement of these threads during the phase of assembling the crown, which placement diameter depending on the profile of the placement surface of the crown form. These displacements determine the formation rate in the press.

Thus, by varying the law relating to the force/elongation of the zero-degree reinforcing thread, and by knowing the transverse profile of the placement surface, and the profile of the mould, it is possible to deduce therefrom the elongation rate at any point sustained by the zero-degree thread between the assembly phase and the moulding operation, and to thus calculate the prestress conferred on the thread during the formation of the tire element in the curing press.

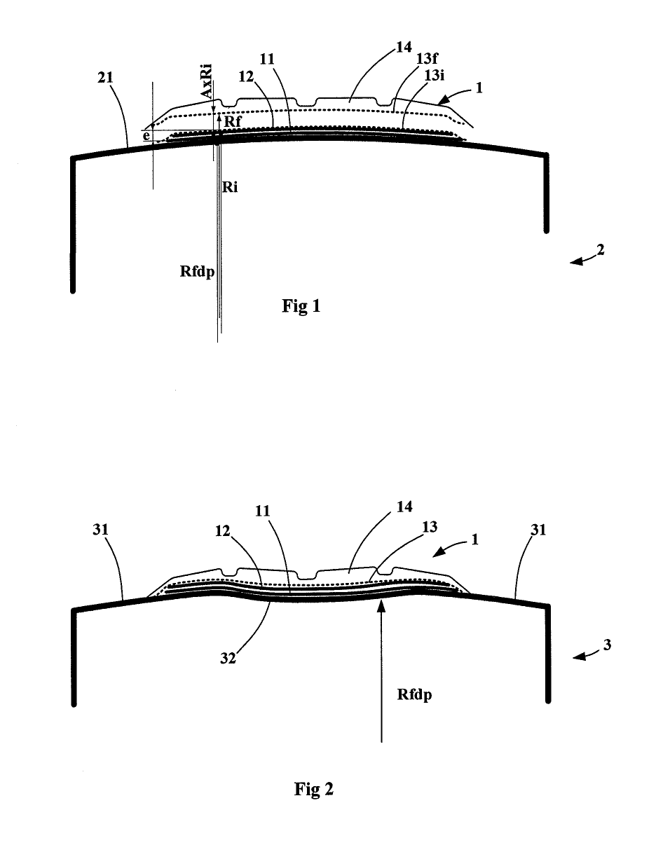

The following description is based on an exemplary embodiment providing a better understanding of the particular embodiments of the invention, and on FIGS. 1 and 2 in which:

FIG. 1 represents a view in radial section of a crown assembly form having a concavity oriented radially inwards.

FIG. 2 represents a view in radial section of a crown assembly form having a double concavity.

The crown assembly form 2 illustrated in FIG. 1 comprises a placement surface 21 on which a tire crown 1 has been shown during assembly comprising a first crown reinforcing ply 11 and a second crown reinforcing ply 12. These crown reinforcing plies are usually formed of reinforcing threads forming an angle with the circumferential direction.

The crown also comprises reinforcing threads 13i wound at zero degrees with no tension.

When the tire blank is fitted into the mould, the assembly is covered by a tread 14. The reinforcing plies and in particular the zero-degree reinforcing ply are then placed in their final position 13f.

The transverse profile of the receiving surface designed to receive the components forming the crown belt 2 defined according to the distance Rfdp of the surface to the rotation axis of the assembly form, has a generally concave curve, the concavity of which is oriented radially towards the inside of the assembly form. This configuration may prove useful when it is sought to give a greater tension at the shoulders than at the centre, considering that the transverse profile of the mould in the crown zone is substantially flat.

It will be noted here that, as a general rule, the transverse profile of the mould at the bottom of the sculpture itself has a curve which must be taken into consideration, as has been said above, in calculating the profile of the placement surface of the crown assembly form.

For any zero-degree thread, it is possible to determine, depending on its axial position, the final radius Rf of the thread (in the stressed state) corresponding to the final position of the thread at this point when the tire is fitted into the curing mould and Ri the initial radius of the wrap (radius of placement of the wrap in the unstressed state).

Let e be the thickness (the distance) separating the said thread from the finishing drum. E represents the thickness of the products placed radially beneath the thread in question.

Let T be the tension of this thread in the final state (tension given by the law of tension that it is desired to obtain), and let f(T) be the curve characteristic of the zero-degree thread in question which gives the elongation A (usually in %) of the thread corresponding to a tension level T in which A is a function of T:A=f(T).

Rfdp indicates the radius of the receiving surface that it is desired to determine.

This then gives the relation Rf=Ri+A×Ri where A×Ri which indicates the formation rate in the press that the thread must undergo in order to be in the desired stressed state.

It is deduced from this that Ri=Rf/(1+A)=Rf/(1+f(T)). Where Rfdp=Ri−e. The result of this is that Rfdp=Rf/(1+f(T))−e.

The crown assembly form 3 illustrated in FIG. 2 has a placement surface comprising the combination of two concavities in opposite directions. The two axially opposed wings 31 have a concavity oriented towards the inside of the assembly form, while the central portion 32 situated at the equator of the assembly form has a concavity oriented towards the outside of the crown form. This profile therefore has at least one point of inflection and, as a general rule, at least an even number of inflection points because of the symmetry of the tire, making it possible to connect these curves of different concavities.

This profile makes it possible to confer a pre-tension on the threads situated at the shoulders in order to improve the performance in maximum speed, and to give a pre-tension to the zero-degree threads in the zone of the equator of the tire in order to improve wear performance.

It goes without saying that those skilled in the art will be able to adapt the curve of the placement surface according to profiles that are as varied as the tire performance requirements make themselves felt.

Similarly, it remains evident to combine the effects associated with the geometry of the placement surface as has just been described above with the effects associated with the tensioned placement of the zero-degree reinforcing thread as is carried out currently in the industry. This will give a reinforcement of the pre-tension values conferred on the zero-degree thread while limiting the placement tension of the thread so as to prevent the harmful effects described in the introduction of this document.

Moreover, the latter solution has the advantage of conferring a greater industrial flexibility by allowing the creation of placement forms having carefully determined standard profiles and on which the tension of placement of the zero-degree threads is finely adjusted in order to obtain the desired pre-tension.

1. A method for determining the transverse curve of a receiving surface of generally cylindrical form designed, during the assembly of the tire blank, to receive the components forming a crown belt in which threads are placed at zero degrees relative to the longitudinal direction, the said threads being continuously wound without tension, comprising:
determining the elongation rate to be applied to a turn of a zero-degree thread according to the desired pre-tension (A=f(T)), according to its axial position in the tire;
determining, depending upon the radial position (Rf) of the thread of the said turn in the tire fitted into its mould, the initial radial position (Ri=Rf/(1+A)) so that the thread of the turn in question sustains the desired elongation rate during forming in the press; and
determining the transverse profile (Rfdp) of the receiving surface, in the axial location of the said turn, by subtracting from the initial position of the thread (Ri) the thickness (e) of the components placed radially inside the turn of the said zero-degree thread (Rfdp=Rf/(1+f(T)) e).

2. The method according to claim 1, wherein the tension of the windings of threads varies axially so that the transverse curve of the receiving form has at least one concavity oriented radially outwards.

3. The method according to claim 2, wherein the tension of the windings of threads varies axially so that the transverse curve of the receiving form has at least one concavity oriented radially inwards.
